(19) United States
(12) Patent Application Publication
(10) Pub. No.: US 2008/0314878 A1
(43) Pub. Date: Dec. 25, 2008

(54) APPARATUS AND METHOD FOR CONTROLLING A MACHINING SYSTEM

(75) Inventors: Guoshuang Cai, Shanghai (CN); Yanmin Li, Shanghai (CN); Huan Qi, Niskayuna, NY (US); Xiaoping Huang, Shanghai (CN); Zhixue Peng, Shanghai (CN); Kevin George Harding, Niskayuna, NY (US); Magdi Naim Azer, Niskayuna, NY (US); Robert William Tait, Brighton, MI (US); Prashant Madhukar Kulkarni, Niskayuna, NY (US)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: GENERAL ELECTRIC COMPANY, SCHENECTADY, NY (US)

(21) Appl. No.: 11/767,004

(22) Filed: Jun. 22, 2007

(51) Int. Cl. B23K 26/04; G05B 11/00

(52) U.S. Cl. 219/121.62; 700/67

(57) ABSTRACT

An apparatus for controlling a machining system is provided. The apparatus include an optical unit configured to capture an image of an object based upon radiation generated from the object and an image processing unit configured to process the image and to obtain real-time estimation of parameters associated with manufacture or repair of the object. The apparatus also includes a process model configured to establish target values for the parameters associated with the manufacture or repair of the object based upon process parameters for the machining system and a controller configured to control the process parameters for the machining system based upon the estimated and target values of the parameters associated with the manufacture or repair of the object.

### BACKGROUND

The invention relates generally to an apparatus for controlling a machining or a manufacturing system, and more particularly, to an apparatus for controlling process parameters of the machining system based upon real-time measurement of parameters of an object manufactured by the machining system.

Various types of machining processes are known and are in use for manufacturing and repairing parts. For example, laser net-shape machining systems are used to form functional components that are built layer by layer from a computer-aided design (CAD). Typically, such systems employ a laser beam to generate a melt pool. Further, a controlled amount of metal or alloy powder is deposited into the laser-generated melt pool to form a component. Monitoring parameters associated with the melt pool is desirable to control the machining process for achieving a final desired shape and size of the component. Unfortunately, due to the process complexity of such systems, it is very difficult to obtain a real-time estimation of such parameters.

Certain systems employ a two-dimensional (2D) viewing system for monitoring the borders of the melt pool while the system is in operation. However, such viewing systems provide a rough estimate of the melt pool area and do not provide a measurement of parameters such as melt pool width and deposition height of the melt pool. Furthermore, certain systems employ sensors for measuring the height of the accumulated layers. However, such sensors do not have the required measurement resolution, accuracy or the measurement range to provide a reliable measurement. Further, control of the manufacturing or deposition process based upon such parameters may result in components with dimensional variations and poor surface finish and would need additional machining to achieve the desired shape and size.

Accordingly, there is a need for an apparatus that provides an accurate real-time measurement of parameters of an object manufactured by the machining or deposition system. Furthermore, it would be desirable to provide an apparatus that can provide an on-line measurement of the parameters of an object formed by a machining process to facilitate a closed-loop control of the process.

### BRIEF DESCRIPTION

Briefly, according to one embodiment, an apparatus for controlling a machining system is provided. The apparatus includes an optical unit configured to capture an image of an object based upon radiation generated from the object and an image processing unit configured to process the image and to obtain real-time estimation of parameters associated with manufacture or repair of the object. The apparatus also includes a process model configured to establish target values for the parameters associated with the manufacture or repair of the object based upon process parameters for the machining system and a controller configured to control the process parameters for the machining system based upon the estimated and target values of the parameters associated with the manufacture or repair of the object.

In another embodiment, a laser net-shape machining system is provided. The laser net-shape machining system includes a laser configured to generate a melt pool, a nozzle configured to provide a powder material in the melt pool to form an object and an optical unit configured to capture an image of the object based upon radiation generated from the melt pool. The laser net-shape machining system also includes an image processing unit configured to process the image and to obtain real-time estimation of parameters associated with manufacture or repair of the object, a process model configured to establish target values for the parameters associated with the manufacture or repair of the object based upon process parameters for the machining system and a controller configured to control the process parameters for the machining system based upon the estimated and target values of the parameters associated with the manufacture or repair of the object.

In another embodiment, a method for controlling a machining system is provided. The method includes obtaining an image of an object based upon radiation generated from the object and processing the image to estimate parameters associated with manufacture or repair of the object. The method also includes establishing target values for parameters associated with the manufacture or repair of the object based upon process parameters for the machining system and controlling the process parameters for the machining system based upon the estimated and target values of the parameters associated with the manufacture or repair of the object.

### DRAWINGS

These and other features, aspects, and advantages of the present invention will become better understood when the following detailed description is read with reference to the accompanying drawings in which like characters represent like parts throughout the drawings, wherein:

FIG. 1 is a diagrammatical illustration of a laser net-shape machining system having a closed-loop control in accordance with aspects of the present technique.

FIG. 2 is a diagrammatical illustration of an exemplary configuration of the optical unit employed in the laser net-shape machining system of FIG. 1 in accordance with aspects of the present technique.

FIG. 3 is a diagrammatical illustration of an exemplary parameter of the melt pool estimated using the image captured by the optical unit of FIG. 2 in accordance with aspects of the present technique.

FIG. 4 is a diagrammatical illustration of another exemplary parameter of the melt pool estimated using the image captured by the optical unit of FIG. 2 in accordance with aspects of the present technique.

FIG. 5 is a diagrammatical illustration of an exemplary controller employed in the laser net-shape machining system of FIG. 1 for controlling process parameters of the laser net-shape machining system based upon estimated parameters of FIGS. 3 and 4 in accordance with aspects of the present technique.

FIG. 6 is a diagrammatical illustration of an exemplary image processing technique for processing the image captured using the optical unit of FIG. 2 in accordance with aspects of the present technique.

FIG. 7 is a diagrammatical illustration of another exemplary image processing technique for processing the image captured using the optical unit of FIG. 2 in accordance with aspects of the present technique.

FIG. 8 is a diagrammatical illustration of real and ghost images generated from the melt pool using the optical unit of FIG. 2 in accordance with aspects of the present technique.

FIG. 9 is a diagrammatical illustration of an exemplary configuration of a beam splitter employed for separating real and ghost images of FIG. 8 in accordance with aspects of the present technique.

FIG. 10 is a diagrammatical illustration of another exemplary configuration of a beam splitter employed for separating real and ghost images of FIG. 8 in accordance with aspects of the present technique.

FIG. 11 is a diagrammatical illustration of a component manufactured through a closed-loop control of the laser net-shape machining system of FIG. 1 in accordance with aspects of the present technique.

FIG. 12 is a diagrammatical illustration of a component manufactured without a closed-loop control of the laser net-shape machining system of FIG. 1.

### DETAILED DESCRIPTION

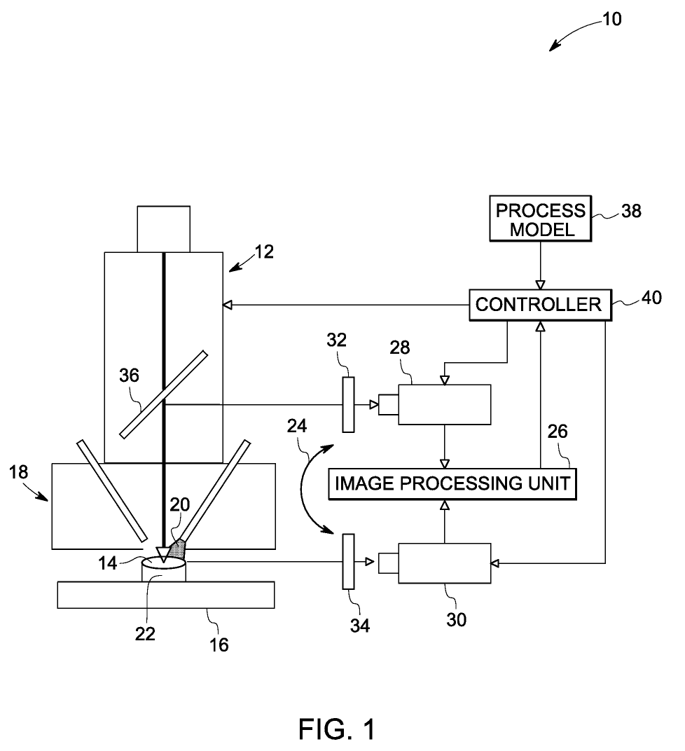

As discussed in detail below, embodiments of the present technique function to provide a real-time measurement of parameters associated with manufacture or repair of an object using a machining or manufacturing system. Further, an adaptive control technique is employed to control process parameters of the machining system based upon the real-time measurement and target values for the parameters associated with the manufacture or repair of the object. Referring now to the drawings, FIG. 1 is a diagrammatical illustration of a machining or a manufacturing system 10 having a closed-loop control in accordance with aspects of the present technique. In this exemplary embodiment, the machining system 10 includes a laser net-shape machining (LNSM) system. The laser net-shape machining system 10 includes a laser 12 configured to generate a melt pool 14 on a substrate 16 and a nozzle 18 configured to provide a powder material 20 to form an object 22. Further, the laser net-shape machining system 10 includes an optical unit 24 configured to capture an image of the object 22 based upon radiation generated from the melt pool 14. Advantageously, such self luminous characteristic of the melt pool 14 eliminates the need of external illuminators for capturing an image of the melt pool 14 and also enables measurement of radiation intensity of the melt pool 14 without external disturbances. In this exemplary embodiment, the optical unit 24 and the laser 12 are positioned such than an axis of the laser beam generated from the laser 12 is concurrent with an axis of the optical unit 24. Beneficially, such co-axial set up of the optical unit 24 and the laser 12 facilitates the melt pool image to be positioned at a fixed location without having distortion in any moving directions.

In addition, an image processing unit 26 is employed to process the image captured by the optical unit 24 and to obtain real-time estimation of parameters associated with the manufacture or repair of the object 22. Examples of such parameters include a melt pool width, a deposition height of the melt pool 14, a length of melt pool 14, a temperature of the melt pool 14 and so forth.

In this exemplary embodiment, the optical unit 24 includes a first imaging camera 28 configured to capture a first image of the object 22 for monitoring the width of the melt pool 14. In addition, the optical unit 24 includes a second imaging camera 30 configured to capture a second image of the object 22 for monitoring the deposition height of the melt pool 14. Examples of the first and second imaging cameras 28 and 30 include complementary metal oxide semiconductor (CMOS) cameras, charge couple device (CCD) cameras and so forth. In this exemplary embodiment, high pass filters such as represented by reference numerals 32 and 34 may be coupled to the first and second imaging camera 28 and 30 respectively. Further, the laser net-shape machining system 10 also includes a beam splitter 36 configured to split illumination from the object 22 for inputs to the first and second imaging cameras 28 and 30 respectively.

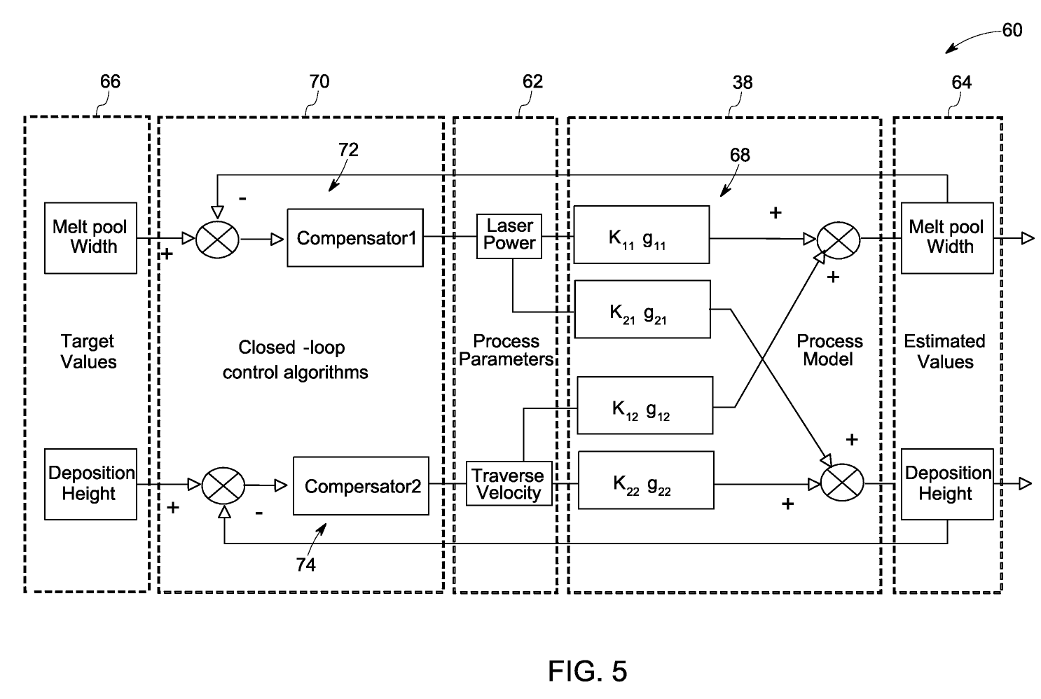

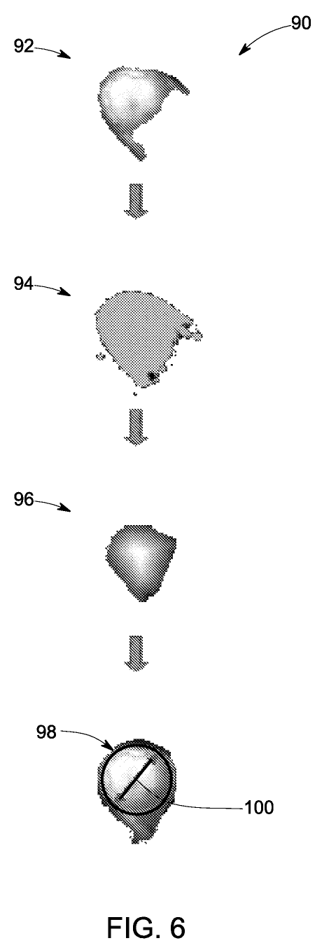

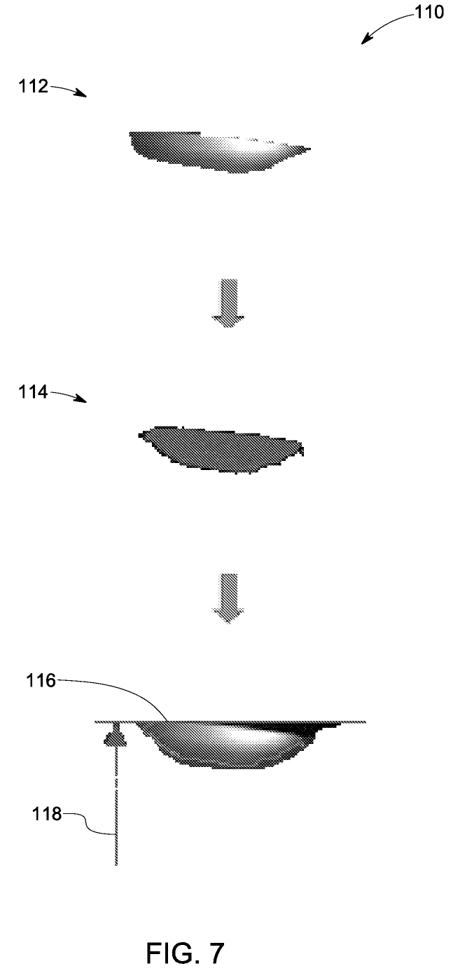

Moreover, the laser net-shape machining system 10 includes a process model 38 that is configured to establish target values for the parameters associated with the manufacture or repair of the object 22 based upon process parameters for the machining system 10. Examples of process parameters include a laser power, a traverse velocity, a powder material feed rate, and so forth. The laser net-shape machining system 10 also includes a controller 40 that is configured to control the process parameters of the laser net-shape machining system 10 based upon the estimated and target values of the parameters associated with the manufacture or repair of the object 22. The estimation of the parameters associated with the manufacture or repair of the object using the image captured through the optical unit will be described below with reference to FIGS. 6-7. Further, the control of the process parameters of the laser net-shape machining system 10 based upon the estimated and target values of the parameters associated with the manufacture or repair of the object will be described in detail below with reference to FIG. 5.

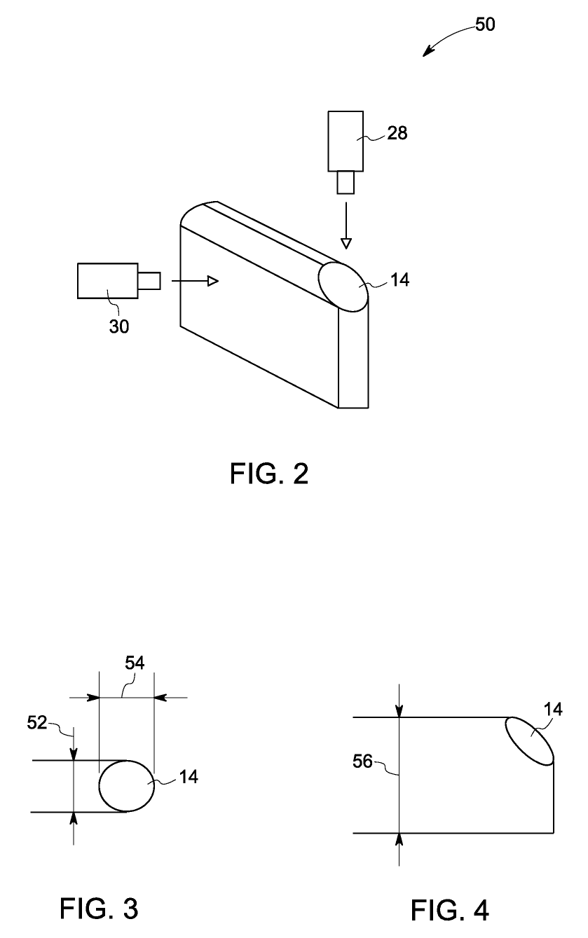

FIG. 2 is a diagrammatical illustration of an exemplary configuration 50 of the optical unit 24 employed in the laser net-shape machining system 10 of FIG. 1 for capturing an image of the melt pool 14 in accordance with aspects of the present technique. As illustrated, the optical unit 50 includes the first and second imaging cameras 28 and 30 configured to capture first and second images of the melt pool 14. The first and second images are subsequently processed by the imaging processing unit 26 (see FIG. 1) for real-time estimation of parameters associated with the manufacture or repair of the object 22 (see FIG. 1). In the illustrated embodiment, the first and second images are processed to estimate a melt pool width 52, a melt pool length 54 and a deposition height 56 of the melt pool 14 as illustrated in FIGS. 3 and 4, respectively. In another exemplary embodiment, the image captured by the first and second imaging cameras 28 and 30 may be processed to estimate a temperature of the melt pool 14. As illustrated, the optical unit 50 includes two imaging cameras 28 and 30. However, a greater or a lesser number of imaging cameras may be employed for estimation of a desired number of parameters associated with the manufacturing or repair of the object 22.

The first and second images captured using the first and second imaging cameras 28 and 30 are processed by the image processing unit 26. In this exemplary embodiment, the image processing unit 26 employs an image processing algorithm for processing the first and second images to estimate the parameters associated with the manufacture or repair of the object 22. Examples of the image processing algorithms include, but are not limited to blob analysis, maximum inside circle analysis, and clipper. Such image processing algorithms will be described in detail below with reference to FIGS. 6-7.

The parameters, such as the melt pool width 52, melt pool length 54 and the deposition height 56 of the melt pool 14, estimated using the first and second images are further utilized to control the process parameters for the laser net-shape machining system 10. FIG. 5 is a diagrammatical illustration of an exemplary controller 60 employed in the laser net-shape machining system 10 of FIG. 1 for controlling process parameters 62 of the laser net-shape machining system 10 based upon estimated parameters 52, 54 and 56 of FIGS. 3 and 4 in accordance with aspects of the present technique. In this exemplary embodiment, the controller 60 is configured to receive estimated values 64 of the parameters such as the melt pool width 52 and the deposition height 56 of the melt pool associated with the manufacture or repair of the object 22 (see FIG. 1) from the image processing unit 26.

Further, the controller 60 is configured to receive target values 66 of the parameters such as the melt pool width 52 and the deposition height 56 associated with the manufacture or repair of the object 22 from the process model 38. In the illustrated embodiment, the process model 38 includes a parametric model 68 that is configured to simulate the process for manufacturing or repair of the object using the laser net-shape machining system 10 to establish the target values 66 for the parameters associated with the manufacture or repair of the object 22. In certain embodiments, the parametric model 68 may be developed using experimental data and mathematical equations. In particular, the parametric model 68 may be configured to simulate the process for manufacturing or repair of the object 22 using the laser net-shape machining system 10 to establish the target values 66 for the parameters for a plurality of operating conditions of the machining system 10.

In an exemplary embodiment, the process model 38 includes an auto regressive with moving average extra input signal (ARMAX) model. The controller 60 is configured to control the process parameters 62 based upon the estimated and target values 64 and 66 of the parameters associated with the manufacture or repair of the object 22. In this exemplary embodiment, the process parameters 62 include a laser power and a traverse velocity. However, other process parameters 62 of the manufacturing system 10 may be controlled using the controller 60.

In the illustrated embodiment, the controller 60 includes closed-loop control algorithms 70 for controlling the process parameters 62 of the manufacturing system 10 based upon the estimated and target values 64 and 66 of the parameters associated with the manufacture or repair of the object 22. In this exemplary embodiment, the controller 60 includes first and second control loops 72 and 74 configured to control the laser power and traversal velocity based upon the estimated and target values 62 and 64 of the melt pool width and the deposition height respectively. It should be noted that the first and second control loops 72 and 74 may function independently or in combination for controlling the process parameters 62 of the laser net-shape manufacturing system 10. In one embodiment, the controller 60 includes a proportional-integral-derivative (PID) controller, or a predictive controller, or a fuzzy controller. However, other types of controllers may be employed. In certain embodiments, the controller 60 is configured to control the operational settings of the first and second imaging cameras 28 and 30 (see FIG. 1).

As noted above, the image processing unit 26 (see FIG. 1) employs an image processing algorithm for processing the first and second images from the first and second imaging cameras 28 and 30 for estimating the parameters associated with the manufacture or repair of the object 22. FIG. 6 is a diagrammatical illustration of an exemplary image processing technique 90 for processing the image captured using the optical unit 50 of FIG. 2 in accordance with aspects of the present technique. In this exemplary embodiment, the image processing technique 90 includes maximum inside circle analysis for estimation of the melt-pool width 52 (see FIG. 3) of the melt pool 14 (see FIG. 3). As illustrated, the first imaging camera 28 (see FIG. 2) is employed to capture an image 92 of the melt pool 14. The image 92 is then binarized to segment the object from the background to form a binary large object (blob) 94. In this embodiment, the pixels in the blob 94 have a gray-level value that is greater than a preset threshold value. Further, the pixels in the background have a gray-level value that is less than the preset threshold value.

In one embodiment, a biggest blob 96 is selected and a distance of each pixel inside the blob 96 from the boundary of the blob 96 is estimated. Further, the distance of a pixel farthest from the boundary of the blob 96 is selected. This distance may be represented as a radius of a maximum inside circle 98 of the melt pool 14. Moreover, a diameter of the circle 100 is representative of the melt pool width 52 of the melt pool 14.

FIG. 7 is a diagram illustrating another exemplary image processing technique 110 for processing the image captured using the optical unit 50 of FIG. 2 in accordance with aspects of the present technique. In this exemplary embodiment, the image processing technique 110 includes blob analysis for estimation of the deposition height 56 (see FIG. 4) of the melt pool 14 (see FIG. 3). As illustrated, the second imaging camera 30 (see FIG. 2) is employed to capture an image 112 of the melt pool 14. The image 112 is then binarized to segment object from the background to form a binary large object (blob) 114. In this embodiment, the pixels in the blob 114 have a gray-level value that is greater than a preset threshold value. Further, the pixels in the background have a gray-level value that is less than the preset threshold value. In one embodiment, a top pixel 116 in the blob 114 is identified and a distance 118 of the top pixel from the substrate 16 (see FIG. 1) is a measure of the deposition height 56 of the melt pool 14.

As described above, image processing techniques such as the maximum inside circle analysis and blob analysis may be employed for estimating the parameters such as the melt-pool width 52 and the deposition height 56 of the melt pool 14. However, a plurality of other suitable image processing techniques may be employed to estimate the parameters associated with the manufacture or repair of the object 22 using the images captured through the optical unit 50.

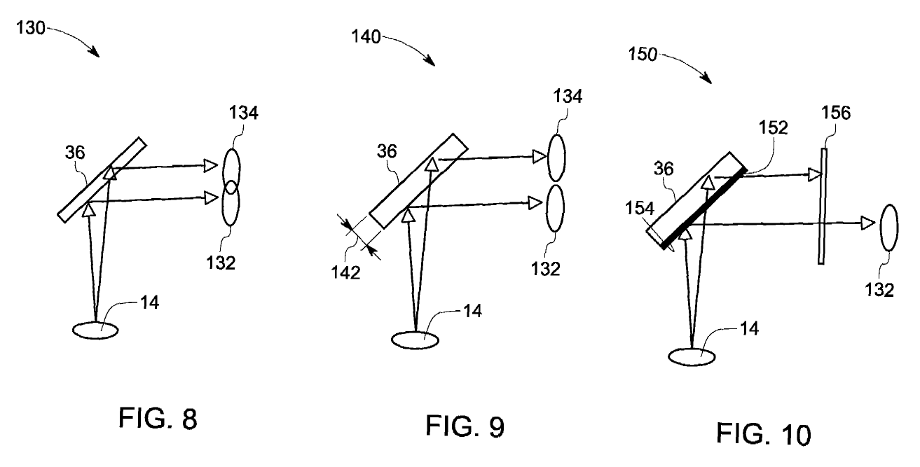

The laser net-shape machining system 10 of FIG. 1 includes the beam splitter 36 is configured to split illumination from the object 22 for inputs to the first and second imaging cameras 28 and 30. In one embodiment, the beam splitter 36 causes generation of two images from the melt pool 14. FIG. 8 is a diagrammatical illustration of real and ghost images 130 generated from the melt pool 14 of FIG. 1 using the optical unit 50 of FIG. 2 in accordance with aspects of the present technique. As illustrated, a real image 132 is generated from a bottom surface of the beam splitter 36. Further, a ghost image 134 is generated from a top surface of the beam splitter 36. In certain embodiments, the ghost image 134 may affect the image quality and measurement accuracy of the parameters estimated from the image due to the overlap between the real and ghost images 132 and 134.

FIG. 9 is a diagrammatical illustration of an exemplary configuration 140 of the beam splitter 36 employed for separating real and ghost images 132 and 134 of FIG. 8 in accordance with aspects of the present technique. In the illustrated embodiment, a thickness 142 of the beam splitter 36 is selected to increase the distance between the real and ghost images 132 and 134 for separating the real and ghost images 132 and 134. As a result, the overlap between the real and ghost images 132 and 134 is eliminated thereby enhancing the image quality. FIG. 10 is a diagrammatical illustration of another exemplary configuration 150 of the beam splitter 36 employed for separating real and ghost images 132 and 134 of FIG. 8 in accordance with aspects of the present technique. In this exemplary embodiment, the beam splitter 36 includes a coating 152 deposited on a reflecting surface 154 of the beam splitter. Further, a filter 156 is positioned in front of the first imaging camera 28 for filtering the ghost image 134 generated from the melt pool 14. Thus, the ghost image 134 is completely eliminated and the first imaging camera receives the real image 132 corresponding to the melt pool.

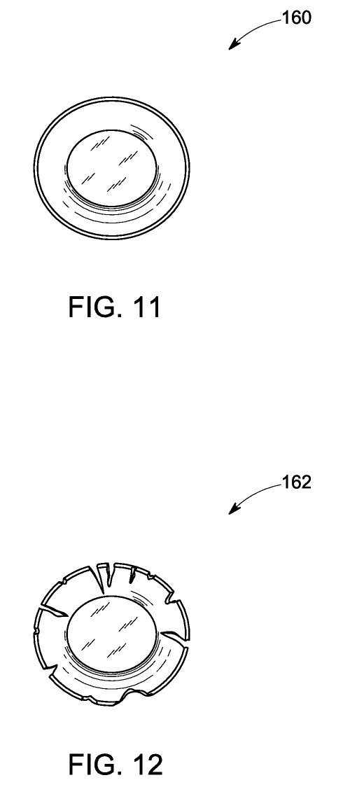

As described above, an adaptive control technique is employed to control process parameters 62 (see FIG. 5) of the laser net-shape machining system 10 (see FIG. 1) based upon the real-time measurement 64 and target values 66 for the parameters associated with the manufacture or repair of the object. Advantageously, such closed-loop control of the process parameters 62 substantially enhances the deposition geometry accuracy of the object 22 formed using the laser net-shape machining system 10. FIG. 11 illustrates a component 160 manufactured with a closed-loop control of the laser net-shape machining system of FIG. 1. FIG. 12 illustrates a component 162 manufactured without a closed-loop control of a laser net-shape machining system. As can be seen, the component 160 formed by the closed-loop control of the process parameters of machining system 10 has relatively better geometric accuracy as compared to the component 162 formed without the closed-loop control of the process parameters of machining system 10.

The various aspects of the method described hereinabove have utility in different machining applications. The technique illustrated above may be used for providing a real-time measurement of parameters associated with a manufacturing or repair operation of an object using a machining system. The technique may also be used for a closed-loop control of the machining system based upon estimated and target values of the parameters to improve the geometric accuracy of the objects manufactured using the machining system. Advantageously, the present technique facilitates substantially fast and customized manufacture or repair of objects with complex shapes such as airfoils. Further, the technique facilitates near net shape manufacturing of complex shapes without a need for additional machining thereby reducing the cost of manufacturing and repair of complex objects.

While only certain features of the invention have been illustrated and described herein, many modifications and changes will occur to those skilled in the art. It is, therefore, to be understood that the appended claims are intended to cover all such modifications and changes as fall within the true spirit of the invention.

1. An apparatus for controlling a machining system, comprising:
an optical unit configured to capture an image of an object based upon radiation generated from the object;
an image processing unit configured to process the image and to obtain real-time estimation of parameters associated with manufacture or repair of the object;
a process model configured to establish target values for the parameters associated with the manufacture or repair of the object based upon process parameters for the machining system; and
a controller configured to control the process parameters for the machining system based upon the estimated and target values of the parameters associated with the manufacture or repair of the object.

2. The apparatus of claim 1, wherein the optical unit comprises a complementary metal oxide semiconductor (CMOS) camera, or a charge couple device (CCD) camera.

3. The apparatus of claim 1, wherein the process model comprises a parametric model that is configured to simulate a process for manufacturing or repair of the object using the machining system to establish the target values for the parameters associated with the manufacture or repair of the object for a plurality of operating conditions of the machining system.

4. The apparatus of claim 3, wherein the process model comprises an auto regressive with moving average extra input signal (ARMAX) model.

5. The apparatus of claim 1, wherein the controller comprises a proportional-integral-derivative (PID) controller, or a predictive controller, or a fuzzy controller.

6. The apparatus of claim 1, further comprising a filter for substantially eliminating a ghost image generated from the object.

7. The apparatus of claim 1, wherein the machining system comprises a laser net-shape machining system.

8. The apparatus of claim 7, wherein the optical unit is configured to capture the image based on the radiation of a laser generated melt pool.

9. The apparatus of claim 7, wherein the parameters associated with the manufacture or repair of the object comprise a melt pool width, or a melt pool length, or a deposition height of the melt pool, or a temperature of the melt pool, or combinations thereof.

10. The apparatus of claim 9, wherein the optical unit comprises:
a first imaging camera configured to capture a first image of the object for monitoring the melt pool width or melt pool length, or combinations thereof; and a second imaging camera configured to capture a second image of the object for monitoring the deposition height of the melt pool.

11. The apparatus of claim 7, wherein the process parameters comprise a laser power, or a traverse velocity, or a material feed rate, or combinations thereof.

12. A laser net-shape machining system, comprising:
a laser configured to generate a melt pool;
a nozzle configured to provide a powder material in the melt pool to form an object;
an optical unit configured to capture an image of the object based upon radiation generated from the melt pool;
an image processing unit configured to process the image and to obtain real-time estimation of parameters associated with manufacture or repair of the object;
a process model configured to establish target values for the parameters associated with the manufacture or repair of the object based upon process parameters for the machining system; and
a controller configured to control the process parameters for the machining system based upon the estimated and target values of the parameters associated with the manufacture or repair of the object.

13. The machining system of claim 12, wherein the parameters associated with the manufacture or repair of the object comprise a melt pool width, or melt pool length, or a deposition height of the melt pool, or a temperature of the melt pool, or combinations thereof.

14. The machining system of claim 13, wherein the optical unit comprises:
a first imaging camera configured to capture a first image of the object for monitoring the melt pool width, or melt pool length, or combinations thereof; and
a second imaging camera configured to capture a second image of the object for monitoring the deposition height of the melt pool.

15. The machining system of claim 14, wherein the first and second imaging camera comprise a complementary metal oxide semiconductor (CMOS) camera, or a charge couple device (CCD) camera, or combinations thereof.

16. The machining system of claim 14, further comprising:
a beam splitter configured to split illumination from the object for inputs to the first and second imaging cameras; and
a filter optically coupled to the beam splitter and configured to eliminate a ghost image generated from the object.

17. The machining system of claim 13, wherein the image processing unit employs image processing algorithms to obtain real-time estimation of the melt pool width, or the melt pool length, or the deposition height of the melt pool, or the temperature of the melt pool, or combinations thereof.

18. The machining system of claim 17, wherein the image processing unit employs a blob analysis, or a maximum inside circle analysis, or a clipper for estimation of the melt-pool width, or a melt pool length and a clipper for estimation of the deposition height.

19. The machining system of claim 12, wherein the optical unit and the laser are positioned such that an axis of a laser beam generated from the laser is concurrent with an axis of the optical unit.

20. The machining system of claim 12, wherein the process parameters comprise a laser power, or a traverse velocity, or a material feed rate, or combinations thereof.

21. The machining system of claim 20, wherein the controller comprises:
a first control loop configured to control the laser power based upon the estimated and target values of the melt pool width and the melt pool length; and
a second control loop configured to control the traversal velocity based upon estimated and target values of the deposition height of the melt pool, wherein the first and second control loops are configured to operate simultaneously, or independently for controlling the process parameters of the machining system.

22. The machining system of claim 21, wherein the controller comprises a proportional-integral-derivative (PID) controller, or a predictive controller, or a fuzzy controller.

23. The machining system of claim 20, wherein the controller comprises:
a first control loop configured to control the laser power based upon the estimated and target values of the melt pool height; and
a second control loop configured to control the traverse velocity based upon estimated and target values of the deposition width of the melt pool and the melt pool length, wherein the first and second control loops are configured to operate simultaneously, or independently for controlling the process parameters of the machining system.

24. The machining system of claim 12, wherein the process model comprises a parametric model that is configured to simulate a process for manufacturing or repair of the object using the machining system to establish the target values for the parameters associated with the manufacture or repair of the object for a plurality of operating conditions of the machining system.

25. The machining system of claim 24, wherein the process model comprises an auto regressive with moving average extra input signal (ARMAX) model.

26. A method for controlling a machining system, comprising:
obtaining an image of an object based upon radiation generated from the object;
processing the image to estimate parameters associated with manufacture or repair of the object;
establishing target values for parameters associated with the manufacture or repair of the object based upon process parameters for the machining system; and
controlling the process parameters for the machining system based upon the estimated and target values of the parameters associated with the manufacture or repair of the object.

27. The method of claim 26 wherein the establishing step comprises using a parametric process model for estimating the target values for parameters associated with the manufacture or repair of the object based upon the process parameters for the machining system.

28. The method of claim 26 wherein the machining system comprises a laser net-shape manufacturing system.

29. The method of claim 28, wherein the parameters associated with the manufacture or repair of the object comprise a melt pool width, or a melt pool length, or a deposition height of the melt pool, or a temperature of the melt pool, or combinations thereof.
